(19) United States
(12) Patent Application Publication
(10) Pub. No.: US 2022/0241142 A1
(43) Pub. Date: Aug. 4, 2022

(54) MASSAGE APPARATUS AND METHODS OF USING SAME

(71) Applicant: WH Orthopaedic Product Development LLC, Pawleys Island, SC (US)

(72) Inventors: William WHITESIDE, Pawleys Island, SC (US); Clarence Ralph Hooper, Charleston, SC (US)

(21) Appl. No.: 17/725,973

(22) Filed: Apr. 21, 2022

Related U.S. Application Data
(63) Continuation-in-part of application No. 16/261,107, filed on Jan. 29, 2019.
(60) Provisional application No. 62/623,612, filed on Jan. 30, 2018.

(51) Int. Cl. A61H 15/00

(52) U.S. Cl. CPC A61H 15/00; A61H 2205/12; A61H 2201/0214; A61H 2015/0028; A61H 2201/0207; A61H 2201/1695

(57) ABSTRACT

A massage apparatus for the treatment of plantar fasciitis or heel pain or heel spur syndrome, comprising: a core including one or more grooves around the circumference thereof; and, one or more bands sized and shaped for insertion into the one or more grooves.

### RELATED APPLICATIONS

This application is a continuation-in-part of and claims priority under 35 U.S.C. § 120 to U.S. patent application Ser. No. 16/261,107, filed Jan. 29, 2019 and is related to U.S. Pat. App. Ser. No. 62/623,612 filed on Jan. 30, 2018, the contents of which are incorporated herein in their entirety.

### FIELD AND BACKGROUND OF THE INVENTION

The present invention, in some embodiments thereof, relates to the healthcare field and, more particularly, but not exclusively, to a massage apparatus.

Body afflictions which can benefit from massage therapy occur often and in a wide spectrum of the population. Inexpensive, effective and convenient remedies are typically hard to find and often involve seeking a professional healthcare professional to provide treatment.

About 75-80 percent of Americans will experience some type of foot or ankle problem in their lifetime ranging from fractures or sprains to Achilles and plantar fasciitis problems. Plantar fasciitis is a very common condition affecting approximately 1 in 10 individuals. Plantar fasciitis is the most common cause of pain in the heel or arch of the foot. It is inflammation of the band of tissue that runs from the heel to the toes.

### SUMMARY OF THE INVENTION

According to an aspect of some embodiments of the present invention there is provided a massage apparatus for the treatment of plantar fasciitis or heel pain or heel spur syndrome, comprising: a core including one or more grooves around a circumference thereof; and, one or more bands sized and shaped for insertion into the one or more grooves.

In an embodiment of the invention, the core is oblong, spherical, ovoid, or football shaped.

In an embodiment of the invention, the core is 2-6 inches in length and 2-4 inches in radius.

In an embodiment of the invention, the massage apparatus weighs between 8 oz. and 24 oz.

In an embodiment of the invention, the core is constructed of a thermally conductive material.

In an embodiment of the invention, at least one of the core and the one or more bands is waterproof.

In an embodiment of the invention, the core is of unitary construction.

In an embodiment of the invention, there are more grooves than bands.

In an embodiment of the invention, at least one of the one or more grooves is 0.38 inches in diameter and wherein at least one of the one or more grooves is 0.63 inches.

In an embodiment of the invention, not all of the grooves are identically sized and shaped.

In an embodiment of the invention, all of the grooves exhibit the same size and shape.

In an embodiment of the invention, the one or more bands are press-fit into the one or more grooves.

In an embodiment of the invention, the one or more bands fit elastically around the core.

In an embodiment of the invention, at least one of the one or more bands includes a texture.

In an embodiment of the invention, the texture is at least one of bumps, raised patterns, spikes and waves.

In an embodiment of the invention, at least some of the one or more bands are interchangeable.

In an embodiment of the invention, the bands are made of at least one of a plastic, elastic and an elastomeric material.

In an embodiment of the invention, the massage apparatus is configured to be stable at rest through at least one of the weight, shape, size, and the one or more bands of the massage apparatus.

According to a further aspect of some embodiments of the present invention there is provided a method of using a massage apparatus, comprising: placing the massage apparatus comprising a core including one or more grooves around a circumference thereof and one or more bands sized and shaped for insertion into the one or more grooves; abutting a user's body part next to the massage apparatus; and, rolling the massage apparatus on the surface by moving the body part against the massage apparatus, thereby applying mechanical massage from the massage apparatus to the body part, wherein the massage apparatus is stable in an at rest configuration before and after the rolling.

In an embodiment of the invention, the method further comprises cooling, freezing or heating the massage apparatus at least one of before and after placing, abutting and rolling the massage apparatus.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example, are not necessarily to scale, and are for purposes of illustrative discussion of embodiments of the invention. In this regard, the description taken with the drawings makes apparent to those skilled in the art how embodiments of the invention may be practiced.

In the drawings:

FIG. 1 is a block diagram depicting a massage apparatus configuration;

FIG. 2 is a cross-sectional view depicting an exemplary massage apparatus;

FIG. 3 is a flowchart of a method of using a massage apparatus of FIG. 1 or FIG. 7;

FIGS. 4-6 are cross-sectional views of exemplary massage apparatuses;

FIG. 7 is a perspective view of an oblong massage apparatus;

FIG. 8 is a reverse perspective view showing a core of the oblong massage apparatus of FIG. 7;

FIG. 9 is a perspective view of the oblong massage apparatus of FIG. 7 in use;

FIG. 10 is a side view showing a core of the oblong massage apparatus of FIG. 7;

FIG. 11 is a side view showing the oblong massage apparatus of FIG. 7;

FIG. 12 is an end view of a core of the oblong massage apparatus of FIG. 7;

FIG. 13 is an end view of the oblong massage apparatus of FIG. 7;

FIG. 14 is a cross-sectional view of FIG. 12; and,

FIG. 15 is a cross-sectional view of FIG. 13.

### DESCRIPTION OF SPECIFIC EMBODIMENTS OF THE INVENTION

The present invention, in some embodiments thereof, relates to the healthcare field and, more particularly, but not exclusively, to a massage apparatus.

Before explaining at least one embodiment of the invention in detail, it is to be understood that the invention is not necessarily limited in its application to the details of construction and the arrangement of the components and/or methods set forth in the following description and/or illustrated in the drawings and/or the pictures. The invention is capable of other embodiments or of being practiced or carried out in various ways. As used herein, “under” or “below” means in the direction of the ground or turf surface and “over” or “above” means in the direction of the sky, opposite the ground.

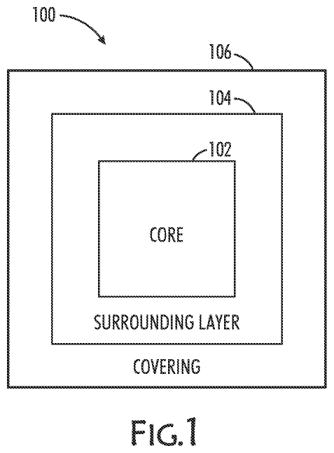

Referring now to the drawings, FIG. 1 is a block diagram depicting a massage apparatus 100 configuration, in accordance with an exemplary embodiment of the invention. In some embodiments, the massage apparatus 100 includes a core 102, a surrounding layer 104 and a covering 106. Generally, the massage apparatus 100 is configured to enable a rolling motion type of massage, while also being configured to not roll when not in use. In some embodiments, the massage apparatus 100 is placed on a flat surface and rolled back and forth under a user's foot to provide a massaging effect on the bottom of the user's foot. This type of massage motion is suited for any number of ailments, but particularly for relieving plantar fasciitis. In some embodiments of the invention, the mechanical massage action is combined with thermal therapy, for example cold or cryotherapy. Optionally, the massage apparatus 100 is offered in a plurality of sizes and/or shapes and/or hardness/pliancy/shiftiness for treating different ailments and/or different body parts and/or for providing differing massaging effects.

In an embodiment of the invention, the core 102 of the massage apparatus 100 is configured with a shape which facilitates rolling, for example being spherical, or ovoid. In some embodiments, the core 102 has a shape (e.g. obovate, pyriform, clavate, rhomboidal) which rolls but not ad infinitum in a single direction, that is it is asymmetrical so that it will roll in a large circle if allowed to. In some embodiments of the invention, the core 102 is constructed of a hard/rigid core, which is filled with or constructed of a thermally conductive substance or at least is filled partially with a thermally conductive substance, where the thermally conductive substance can be cooled and/or frozen and retain the cold temperature for a period of time, for example 20 minutes or more. Optionally, the core is hollow. The core is optionally constructed of a metal or plastic or rubber. In some embodiments, the thermally conductive substance inside the core 102 is a mixture of water and ethyl alcohol. It should be understood that virtually any thermally conductive substance could be used. In practice, it is conceived that the very cold or frozen substance in the core 102 functions as a solid or nearly solid structure against which the user's body part which is being massaged is pressed to provide mechanical massage therapy. In some embodiments of the invention, the core 102 is smooth along its external surface. Optionally, the surface of the core 102 is contoured or provided with protrusions to enhance the mechanical massaging effect.

In some embodiments of the invention, the core 102 is weighted, for example to reduce a rolling tendency of the apparatus 100. Optionally, no cover 106 (described in more detail below) is used since the weighted core 102 prevents or at least reduces the likelihood of the apparatus 100 rolling.

In an embodiment of the invention, the core 102 is entirely enclosed by a surrounding layer 104. The surrounding layer 104 could be constructed of virtually any compressible or squeezable material or combination of materials. The surrounding layer 104 optionally includes an at least partially particulate substance which provides a plurality of advantages to the massage apparatus 100. For example, the particulate nature of the surrounding layer 104 provides the capacity for movement (e.g. rolling) of the massage apparatus 100, but only upon the exertion of sufficient rolling force. That is, the particulate nature of the surrounding layer 104 helps to prevent the massage apparatus 100 from rolling when not being used and/or if nudged accidentally by the user since the overall shape of the surrounding layer 104 will shift at least slightly from the weight of the massage apparatus 100 when the massage apparatus 100 is resting on a surface. Further, the surrounding layer 104 filling is also selected for an ability to provide a modicum of mechanical massage to the user's body part being massaged, for example where the particles of the surrounding layer 104 provide additional massaging to the user in combination with the core 102 itself. In some embodiments, the particulate substance filled surrounding layer 104, when taken as a whole, exhibits an ability to form at least slightly to the user's body part as the particles within the surrounding layer 104 shift under the user's weight and/or from the force applied to the massage apparatus 100 by the user, that is, it is compressible or squeezable and/or retains form memory at least temporarily. In some embodiments the particulate substances filling the surrounding layer 104 are chosen by type and/or by fill percentage (of the layer 104) to configure the surrounding layer 104 to a certain hardness/pliability/shiftiness.

In an embodiment of the invention, the surrounding layer 104 is sealed and fully enclosed by a covering 106. In some embodiments, the covering 106 is flexible and/or formable to the user's body part being massaged. Optionally, the covering 106 is constructed of a pliable, non-slip material, for example silicone or rubber. In some embodiments, the covering 106 is moisture impermeable and/or washable. In some embodiments, the covering 106 exhibits a substantially spherical, obovate, pyriform, clavate, rhomboidal or ovoid shape. In some embodiments, the covering 106 includes contouring and/or protrusions to provide at least one of: additional massaging and apparatus 100 roll control. Optionally, the protrusions are flat-tipped.

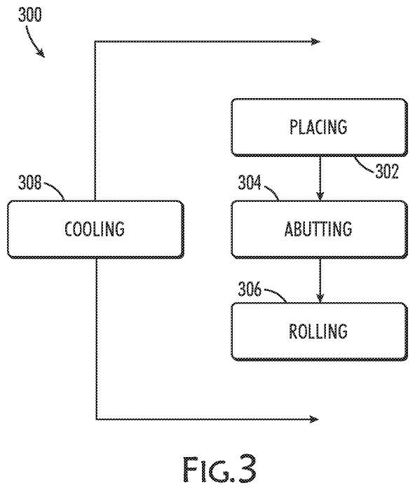

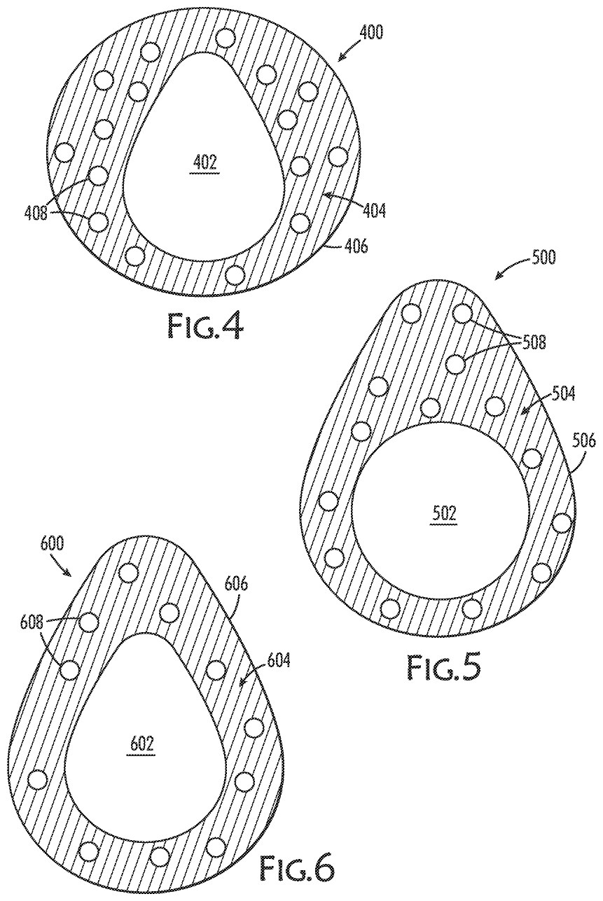

FIGS. 4-6 are cross-sectional views of exemplary massage apparatuses which have vary configurations combining different shaped coverings and cores. For example, FIG. 4 shows a massage apparatus 400 with a generally pyriform shaped core 402, a spherical covering 406 and a surrounding layer 404 with a particulate substance 408 therein. FIG. 5 shows a massage apparatus 500 with a generally spherical shaped core 502, a pyriform covering 506 and a surrounding layer 504 with a particulate substance 508 therein. FIG. 6 shows a massage apparatus 600 with a generally pyriform shaped core 602 and covering 606 and a surrounding layer 604 with a particulate substance 608 therein.

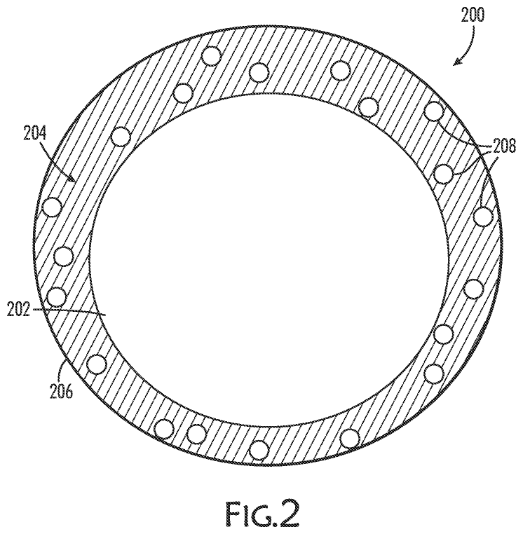

FIG. 2 is a cross-sectional view depicting an exemplary massage apparatus 200 in accordance with the configuration depicted in FIG. 1. In an embodiment of the invention, the massage apparatus comprises a core 202, a surrounding layer 204 and a covering 206. The surrounding layer 204 is configured to behave similarly to a bean bag, but around the core 202. Of particular note, the surrounding layer 204 is shown being comprised of a fine particulate substance, for example sand (the shading), and a coarser particulate substance 208, for example spherical pellets, ice pellets or Therapearls®. Optionally, the coarser particulate substance 208 is also thermally conductive and can provide cryotherapy effects. It should be understood that the surrounding layer 204 does not have to be a particulate substance. It could be a single substance or a combination of a plurality of substances, particulate or not.

In some embodiments of the invention, the core 202 is at least 2 inches in diameter. In some embodiments of the invention, the entire massage apparatus 200 is 3-4 inches in diameter. In some embodiments of the invention, the entire massage apparatus 200 is 2-6 inches in diameter. Optionally, the apparatus 200 is larger than 6 inches in diameter. In some embodiments of the invention, the covering 206 is just a few millimeters thick. Optionally, the covering 206 is thinner or thicker, particularly if it has contouring and/or protrusions. In some embodiments of the invention, the thickness of the covering layer 204 is the difference between the diameter of the entire apparatus 200, optionally minus the thickness of the covering layer 206 if there is one, and the diameter of the core 202. It should be understood that these dimensions are by way of example only.

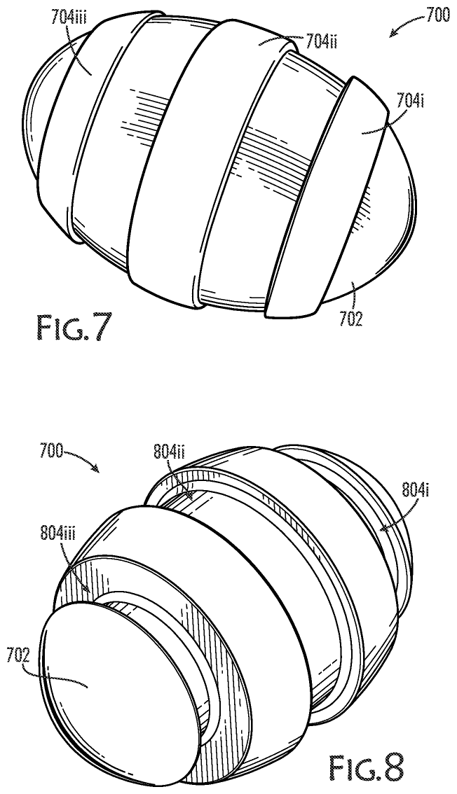

FIG. 3 is a flowchart 300 of a method of using a massage apparatus of FIG. 1, 2 or 7 (the massage apparatus 700 of FIG. 7 described in more detail below). In an embodiment of the invention, the massage apparatus 100, 200, 700 is placed (302) on a surface. Optionally, the surface is a floor, for example under the user's desk or in front of a chair. The user abuts (304) a body part, for example the sole of a foot, next to the massage apparatus 100, 200, 700 and rolls (306) the massage apparatus 100, 200, 700 by moving the body part against the massage apparatus 100, 200, 700, thereby applying mechanical massage therapy to the body part. Optionally, the massage apparatus 100, 200 is cooled/frozen/heated (308) prior to and/or after the placing (302), for example to provide cryotherapy or heat therapy to the body part and/or to cool/freeze/heat the massage apparatus 100, 200, 700 for a subsequent use. In an embodiment of the invention, when not abutting (304) and rolling (306) the massage apparatus 100, 200, 700 with sufficient force to cause rolling, the shifting nature of the surrounding layer 104, 204 particulate substance filling prevents the massage apparatus 100, 200 from rolling away from the user and/or the weight and/or size and/or shape and/or bands render the massage apparatus 700 stable in an at rest configuration.

FIG. 7 is a perspective view of an oblong massage apparatus 700, in accordance with an exemplary embodiment of the invention. In some embodiments of the invention, the oblong massage apparatus 700 is used for the treatment of plantar fasciitis and/or heel pain and/or heel spur syndrome. While described as “oblong”, the massage apparatus 700 could be oblong, spherical, ovoid, football-shaped, or the like. In some embodiments of the invention, the massage apparatus 700 is 2 to 6 inches in length and 2-4 inches in radius (taken from the widest point of a cross-section of the device in the “minor” axis). In some embodiments of the invention, the massage apparatus 700 weighs between 8 oz. and 24 oz. Optionally, the massage apparatus 700 weighs 16 oz. when fully assembled. It should be noted that all of these physical dimensions/characteristics are by way of example only, and that the massage apparatus 700 could be longer or shorter, wider or narrower, and/or heavier or lighter than what is described herein. As described above, the massage apparatus 700 is intended to be used in conjunction with a human foot, in particular the arch and/or the plantar fascia of the foot, so shape and/or size are generally configured, such as described herein, with this use in mind.

Generally, the massage apparatus 700 is comprised of two components, the core 702 and one or more bands 704i, 704ii, 704iii which are placed around the core 702 to form the massage apparatus 700, in an embodiment of the invention. The core 702 is intended to be thermally conductive and/or retentive, for example, to enable the core to be cooled, frozen or heated for treatment enhancement for the user. In some embodiments, the core 702 is constructed of a thermally conductive material such as a metal or metallic/ferrous alloy, a specific example being stainless steel or aluminum. The core 702 is washable and/or for being solid, is waterproof to facilitate cleaning and reusability. In some embodiments of the invention, the core 702 is of unitary construction. The massage apparatus 700, being of unitary and/or metallic construction, is thus configured for supporting a user's body weight as the massage apparatus 700 is used.

With respect to the one or more bands 704i, 704ii, 704iii, they are generally elliptical in nature and are sized and/or shaped to fit within corresponding grooves 804i, 804ii, 804iii. In an embodiment of the invention, the one or more bands 704i, 704ii, 704iii are press-fit into the corresponding grooves 804i, 804ii, 804iii. As mentioned elsewhere, there are one or more bands and relatedly, there are one or more grooves. In some embodiments, there are more grooves than bands, and the bands are placed where desired. Optionally, the bands fit elastically around the core 702 regardless of how many or any grooves exist in the core and, for example, without having to be positioned in a groove.

The bands are removable, washable, and/or interchangeable for example if they wear out and/or if the bands exhibit different surface textures where specific bands may be desired for use on the basis of having different textures. Exemplary textures include bumps, raised patterns, spikes, waves In some embodiments, the bands are made of a plastic and/or an elastic and/or elastomeric substance, such as a plastic or rubber. In an embodiment of the invention, the bands are of unitary construction. In some embodiments of the invention, the bands are compressible, for example by the exertion of pressure on the bands by the user (e.g. the user's foot). In some embodiments of the invention, the weight of the massage apparatus 700 and/or the traction provided by the one or more bands 704i, 704ii, 704iii, and/or the shape of the apparatus 700 render the massage apparatus in a stable configuration (e.g. it doesn't roll freely will merely roll in a circle) absent pressure being applied by the user to the apparatus 700 (i.e. when the massage apparatus 700 is at rest).

FIG. 8 is a reverse perspective view showing the core 702 of the oblong massage apparatus 700 of FIG. 7. In some embodiments of the invention, at least one of the grooves 804i, 804iii is 0.38 inches in diameter and the central groove 804ii, is 0.63 inches. Optionally, the grooves 804i, 804iii are not identically sized and/or shaped. Optionally, all of the grooves 804i, 804ii, 804iii exhibit the same dimensions and/or shape.

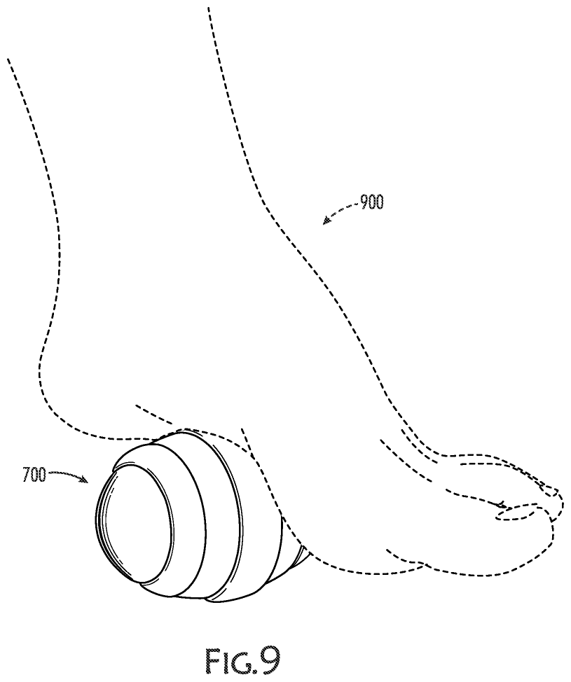

FIG. 9 is a perspective view of the oblong massage apparatus 700 of FIG. 7 in use with a user's foot 900, in an exemplary embodiment of the invention.

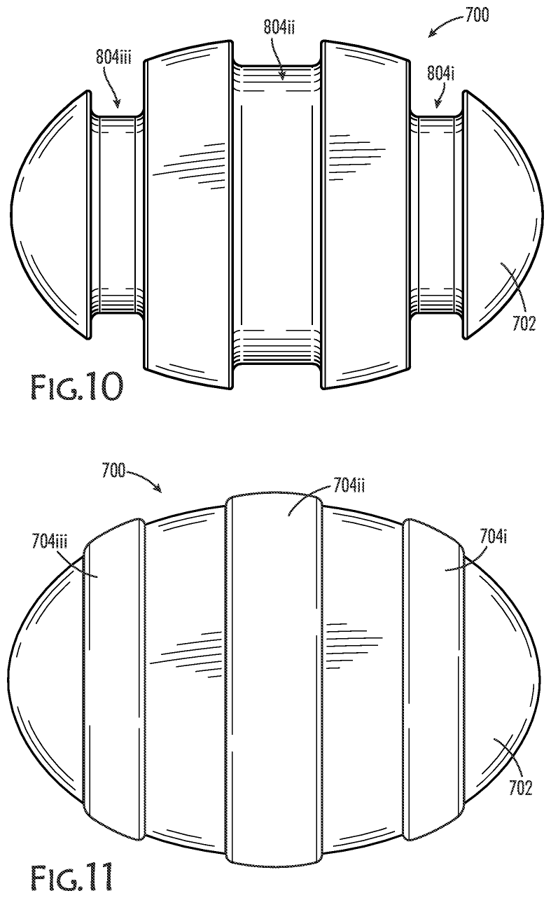

FIG. 10 is a side view showing the core 702 of the oblong massage apparatus 700 of FIG. 7, along with a side view of the one or more corresponding grooves 804i, 804ii, 804iii.

FIG. 11 is a side view showing the oblong massage apparatus 700 of FIG. 7 with the one or more bands 704i, 704ii, 704iii fit into their corresponding grooves 804i, 804ii, 804iii, in accordance with an exemplary embodiment of the invention.

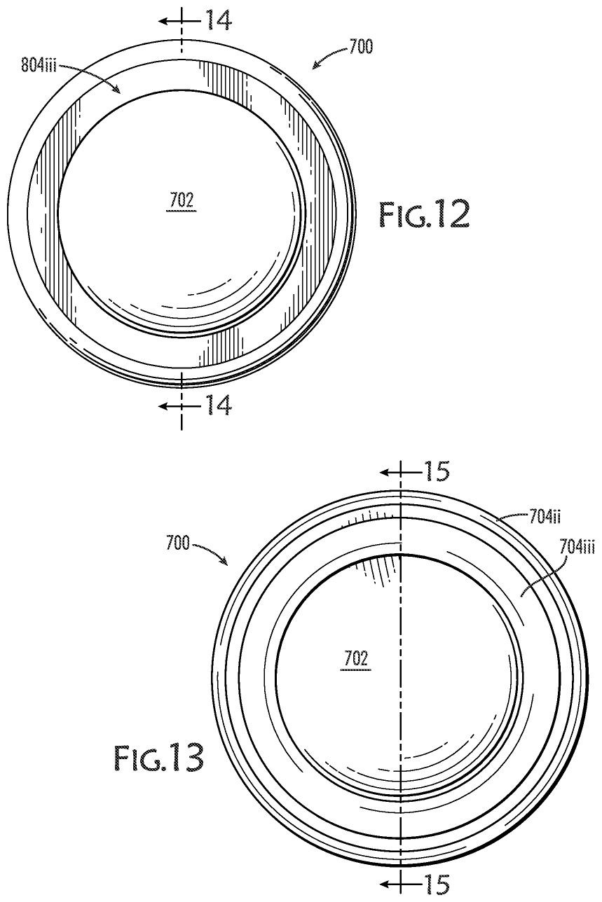

FIG. 12 is an end view of the core 702 of the oblong massage apparatus 700 of FIG. 7, showing the groove 804iii positioned at an end of the core 702, in accordance with an exemplary embodiment of the invention.

FIG. 13 is an end view of the oblong massage apparatus 700 of FIG. 7 showing the band 704iii positioned in the groove 804iii of the core 702 and the band 704ii positioned in the groove 804ii of the core 702, in accordance with an exemplary embodiment of the invention.

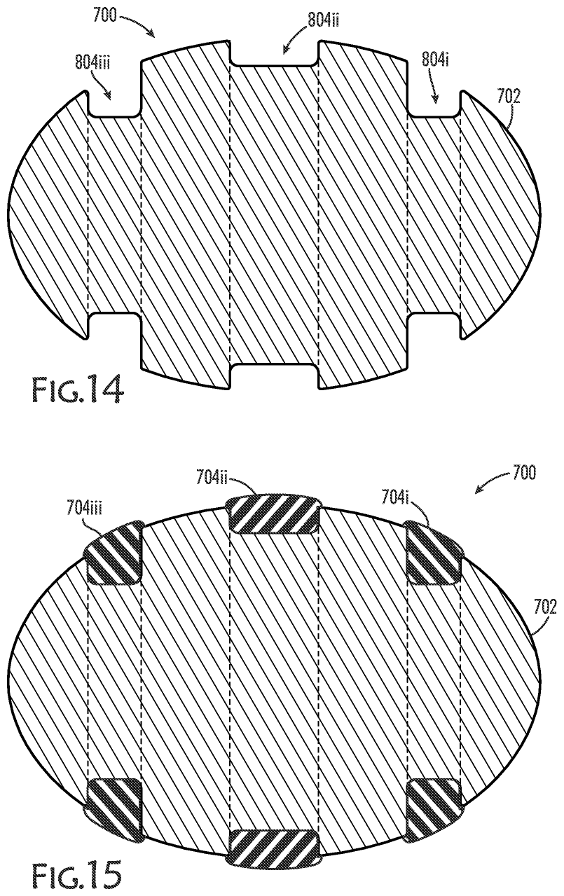

FIG. 14 is a cross-sectional view of the core 702 of FIG. 12, in accordance with an exemplary embodiment of the invention and FIG. 15 is a cross-sectional view of the oblong massage apparatus 700 of FIG. 13.

The terms “comprises”, “comprising”, “includes”, “including”, “having” and their conjugates mean “including but not limited to”.

The term “consisting of” means “including and limited to”.

The term “consisting essentially or means that the composition, method or structure may include additional ingredients, steps and/or parts, but only if” the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range. Further, described ranges are intended to include numbers outside any range described within statistical error and/or inherent measurement equipment limitations.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A massage apparatus for the treatment of plantar fasciitis or heel pain or heel spur syndrome, comprising:
a core including one or more grooves around a circumference thereof; and,
one or more bands sized and shaped for insertion into the one or more grooves.

2. The massage apparatus according to claim 1, wherein the core is oblong, spherical, ovoid, or football shaped.

3. The massage apparatus according to claim 1, wherein the core is 2-6 inches in length and 2-4 inches in radius.

4. The massage apparatus according to claim 1, wherein the massage apparatus weighs between 8 oz. and 24 oz.

5. The massage apparatus according to claim 1, wherein the core is constructed of a thermally conductive material.

6. The massage apparatus according to claim 1, wherein at least one of the core and the one or more bands is waterproof.

7. The massage apparatus according to claim 1, wherein the core is of unitary construction.

8. The massage apparatus according to claim 1, wherein there are more grooves than bands.

9. The massage apparatus according to claim 1, wherein at least one of the one or more grooves is 0.38 inches in diameter and wherein at least one of the one or more grooves is 0.63 inches.

10. The massage apparatus according to claim 1, wherein not all of the grooves are identically sized and shaped.

11. The massage apparatus according to claim 1, wherein all of the grooves exhibit the same size and shape.

12. The massage apparatus according to claim 1, wherein the one or more bands are press-fit into the one or more grooves.

13. The massage apparatus according to claim 1, wherein the one or more bands fit elastically around the core.

14. The massage apparatus according to claim 1, wherein at least one of the one or more bands includes a texture.

15. The massage apparatus according to claim 14, wherein the texture is at least one of bumps, raised patterns, spikes and waves.

16. The massage apparatus according to claim 1, wherein at least some of the one or more bands are interchangeable.

17. The massage apparatus according to claim 1, wherein the bands are made of at least one of a plastic, elastic and an elastomeric material.

18. The massage apparatus according to claim 1, wherein the massage apparatus is configured to be stable at rest through at least one of the weight, shape, size, and the one or more bands of the massage apparatus.

19. A method of using a massage apparatus, comprising:
placing the massage apparatus comprising a core including one or more grooves around a circumference thereof and one or more bands sized and shaped for insertion into the one or more grooves;
abutting a user's body part next to the massage apparatus; and,
rolling the massage apparatus on the surface by moving the body part against the massage apparatus, thereby applying mechanical massage from the massage apparatus to the body part,
wherein the massage apparatus is stable in an at rest configuration before and after the rolling.

20. The method according to claim 19, further comprising cooling, freezing or heating the massage apparatus at least one of before and after placing, abutting and rolling the massage apparatus.
